(19) United States
(12) Patent Application Publication
(10) Pub. No.: US 2010/0262630 A1
(43) Pub. Date: Oct. 14, 2010

(54) ADAPTIVE PROFILE FOR DIRECTING GRAPHICAL CONTENT IN A COMPUTING SYSTEM

(75) Inventors: Daniel Sangster, Bellevue, WA (US); Hakon Strande, Redmond, WA (US); Robert Young, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/423,546

(22) Filed: Apr. 14, 2009

(51) Int. Cl. G06F 7/06

(52) U.S. Cl. 707/805

(57) ABSTRACT

Embodiments for directing graphical user interface elements to an adaptive device are disclosed. One example embodiment includes a method of directing graphical user interface elements to an adaptive device. The method comprises discovering an adaptive device in communication with the computing device. The adaptive device includes one or more graphical display fields and one or more depressible buttons for receiving user input. The method further comprises retrieving an adaptive profile for the adaptive device in response to discovery of the adaptive device. The adaptive profile defines a rule set by which graphical user interface elements are directed to one or more graphical display fields of the adaptive device. The method further comprises presenting the graphical user interface elements at the one or more graphical display fields of the adaptive device according to the rule set of the adaptive profile.

### BACKGROUND

Computing devices may utilize an input device such a keyboard or a mouse to receive user input. Computing devices may also utilize an output device such as a monitor to present graphical information. Some devices, such as touch-sensitive graphical displays, may provide both input and output functionality for a computing device.

### SUMMARY

Embodiments for directing graphical user interface elements to an adaptive device are disclosed. One example embodiment includes a method of directing graphical user interface elements to an adaptive device. The method comprises discovering an adaptive device in communication with the computing device. The adaptive device may include one or more graphical display fields and one or more depressible buttons for receiving user input. The method further comprises retrieving an adaptive profile for the adaptive device in response to discovery of the adaptive device. The adaptive profile defines a rule set by which graphical user interface elements are directed to one or more graphical display fields of the adaptive device. The method further comprises presenting the graphical user interface elements at the one or more graphical display fields of the adaptive device according to the rule set of the adaptive profile.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of an example computing system.

FIG. 2 shows an embodiment of an example method of directing graphical user interface elements to an adaptive device.

FIG. 3 shows an example computing system including an adaptive device.

FIG. 4 shows a schematic representation of an adaptive profile.

FIG. 5 shows another schematic representation of an adaptive profile.

### DETAILED DESCRIPTION

A computing device that is configured to operate with one or more adaptive devices is disclosed in the context of a computing system. An adaptive device may refer to a graphically adaptable device that enables software applications operating at the computing device to dynamically adapt a visual appearance of the adaptive device to a context in which the adaptive device is to be used. For example, a software application operating at the computing device that provides word processing functionality may cause an adaptive device to present one or more graphical user interface elements that are relevant to providing the word processing functionality.

These one or more graphical user interface elements may be used to present the graphical user interface elements for thematic or informational purposes in order to guide or channel user input to a particular depressible button or touch-sensitive region of the adaptive device. This user input may be received by the software application via the adaptive device where it may be processed by the software application. If the context in which the adaptive device changes, such as through user interaction with a second software application, the adaptive device may be dynamically adapted to present one or more different graphical user interface elements that are instead relevant to the second software application.

Software applications that dynamically adapt the visual appearance of an adaptive device may utilize device parameters of the adaptive device to coordinate and direct the presentation of graphical user interface elements at the adaptive device. For example, when adding an adaptive device to the computing system, software applications may seek to utilize device parameters of the adaptive device in order to coordinate and direct the presentation of graphical user interface elements. Challenges may exist for software applications if an adaptive device is not recognized, which may occur, for example, if the software application interacts with a new or unfamiliar adaptive device.

The following disclosure provides an adaptive profile that defines a rule set which may be used by software applications to direct graphical user interface elements to one or more graphical display fields of an adaptive device. The adaptive profile may serve as a link between a software application and an adaptive device that enables the software application to determine where or how graphical user interface elements are to be presented at the adaptive device. It is to be understood that such an adaptive profile may be used to direct graphical content (e.g., user interface elements) to depressible buttons, touch-sensitive regions, and/or gesture-sensitive regions of various adaptive devices. It is also to be understood that such an adaptive profile may additionally or alternatively direct graphical content to display-only devices and/or display-only portions of devices that include input-receiving portions.

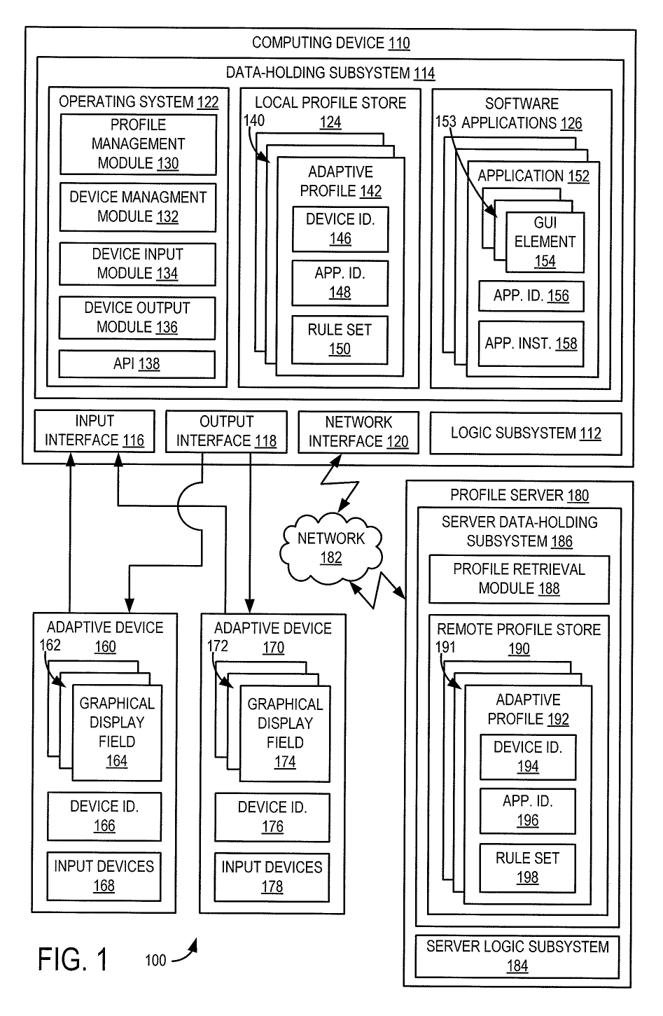

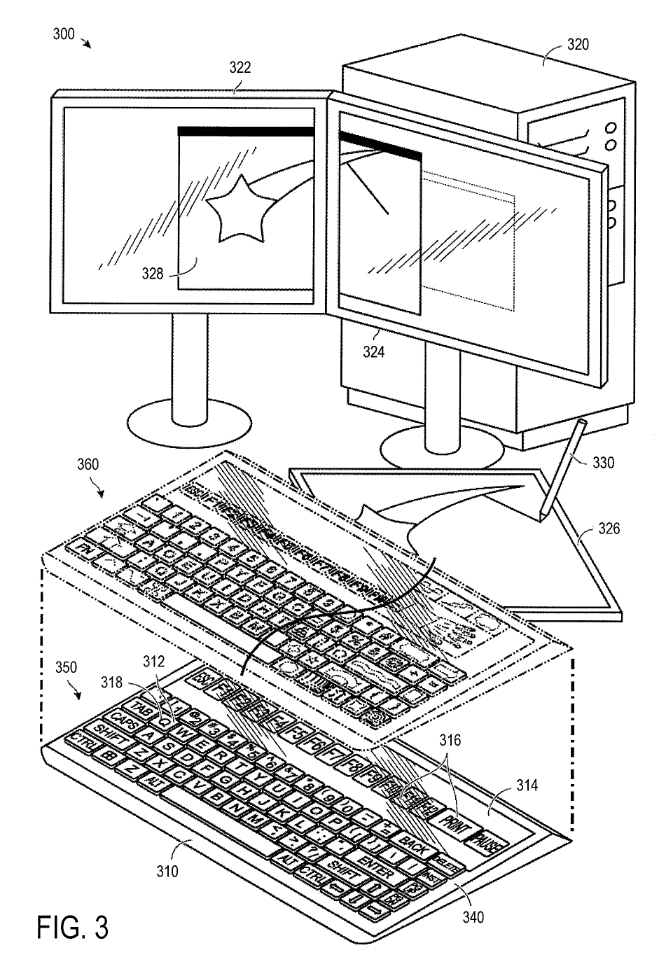

Referring now to FIG. 1, an embodiment of an example computing system 100 is shown. Computing system 100 includes a computing device 110, which may be operated by a user via one or more adaptive devices. For example, a first adaptive device 160 and a second adaptive device 170 are shown in communication with computing device 110 in FIG. 1. A non-limiting example of an adaptive device is described in greater detail with reference to FIG. 3.

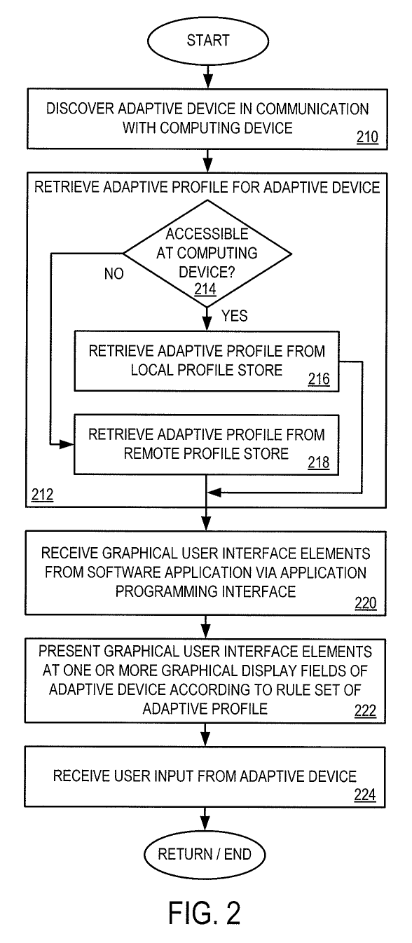

Computing device 110 may include a logic subsystem 112 and a data-holding subsystem 114. Logic subsystem 112 may include one or more processors for executing instructions. Data-holding subsystem 114 may hold instructions executable by the logic subsystem to perform one or more processes. An example of some of the processes that may be performed by logic subsystem 112 of computing device 110 are described in greater detail with reference to method 200 of FIG. 2.

In at least some embodiments, data-holding subsystem 114 may hold instructions that comprise one or more of an operating system 122, a local profile store 124, and one or more software applications 126. Operating system 122 may comprise one or more of a profile management module 130, a device management module 132, a device input module 134, a device output module 136, and an application programming interface (API) 138, each of which will be described in greater detail in the context of method 200 of FIG. 2. In some embodiments, the profile management module may be part of the adaptive device support stack, which is not necessarily part of the operating system.

Briefly, device management module 132 may be configured to discover adaptive devices in communication with computing device 110. Profile management module 130 may be configured to retrieve an adaptive profile for adaptive devices that are discovered by device management module 132. Device input module 134 may be configured to receive user input via the one or more adaptive devices. Device output module 136 may be configured to present one or more graphical user interface (GUI) elements at the adaptive devices. And, application programming interface 138 may be configured to receive the one or more graphical user interface elements from software applications.

Local profile store 124 may include one or more adaptive profiles 140, an example of which is shows as adaptive profile 142. Hence, adaptive profile 142 may be one of a plurality of adaptive profiles stored at local profile store 124. Adaptive profile 142 may include one or more of a device identifier 146, an application identifier 148, and a rule set 150. One or more of the device identifier 146 and application identifier 148 may be referenced by profile management module 130 when retrieving an adaptive profile. Rule set 150 may be used by software applications to direct graphical user interface elements to one or more graphical display fields of the adaptive devices.

Software applications 126 may include one or more software applications, including software application 152. Software application 152 may include one or more graphical user interface (GUI) elements 153, including GUI element 154. GUI element 154 may refer to one or more of an icon, a text character, an image, a video, a pattern, or other suitable graphical information, etc. Software application 152 may also include an application identifier 156 and application instructions 158. Application identifier 156 may be referenced by profile management module 130 to retrieve an appropriate adaptive profile that is associated with the application identifier. Application instructions 158 may include instructions that are executable by logic subsystem 112 to perform the functionality of software application 152, including the provision of graphical user interface elements, the processing of user input, among other suitable software application functionality.

Computing device 110 may further include one or more of an input interface 116 and an output interface 118. Input interface 116 may be configured to facilitate wired and/or wireless input communication on any bus between an adaptive device (e.g., adaptive device 160) and device input module 134. Similarly, output interface 118 may be configured to facilitate wired and/or wireless output communication between device output module 136 and an adaptive device. Computing device 110 may further include a network interface 120 that is configured to facilitate network communication between computing device 110 and network clients (e.g., profile server 180). Network 182 may include one or more of a wide area network (WAN) (e.g., the Internet) and a local area network (LAN) e.g., (an intranet), and may represent wired and/or wireless communication.

Computing system 100 includes two adaptive devices as a non-limiting example. First adaptive device 160 may include one or more graphical display fields 162, an example of which is schematically shown as graphical display field 164. Such a graphical display field may be associated with a depressible button (e.g., keyboard key), a touch display, or another aspect of an adaptive device with a visual appearance that can be dynamically updated and the ability to recognize user input. First adaptive device 160 may include a device identifier 166. Device identifier 166 may be identified by device management module 132 where it may be referenced by profile management module 130 to retrieve an adaptive profile that is associated with the device identifier. In some embodiments, device identifier 166 may indicate device parameters, including one or more of a device size, a number of graphical display fields of the first adaptive device, a size of the graphical display fields, a configuration of the graphical display fields, a type of the graphical display fields (e.g., whether a graphical display field is associated with a depressible button or a touch-sensitive display region of the first adaptive device), and a display capability of the graphical display fields, among other suitable device parameters. First adaptive device 160 may include input devices 168, which may include one or more depressible buttons and/or touch-sensitive display regions for receiving user input. As will be described in greater detail with reference to adaptive device 310 of FIG. 3, one or more graphical display fields may be associated with one or more of the input devices of the adaptive device. For example, each depressible button of the adaptive device may include a respective graphical display field at which a graphical user interface element may be presented.

Second adaptive device 170 may include one or more graphical display fields 172, an example of which is shown as graphical display field 174, a device identifier 176, and input devices 178. First adaptive device 160 may be the same as or different than second adaptive device 170. As one example, first adaptive device 160 may include a greater or lesser number of graphical display fields than second adaptive device 170. As another example, first adaptive device 160 may include a greater or lesser number of input devices (e.g., depressible buttons) than second adaptive device 170. In general, first adaptive device 160 and second adaptive device 170 are both graphically adaptable user input devices that may be visually adapted by computing device 110 and may be used by computing device 110 to receive user input.

Computing system 100 may include a profile server 180, which may include a server logic subsystem 184 and a server data-holding subsystem 186. Server logic subsystem 184 may include one or more processors for executing instructions. Server data-holding subsystem 186 may hold instructions that are executable by one or more of server logic subsystem 184 of profile server 180 and logic subsystem 112 of computing device 110. As one example, server data-holding subsystem 186 may hold instructions comprising one or more of a profile retrieval module 188 and a remote profile store 190. Remote profile store 190 may be configured to hold one or more adaptive profiles 191, such as adaptive profile 192. Hence, adaptive profile 192 may be one of a plurality of adaptive profiles stored at remote profile store 190. Adaptive profile 192 may include one or more of a device identifier 194, an application identifier 196, and a rule set 198, for example, as previously described with reference to adaptive profile 142. Profile retrieval module 188 may be configured to retrieve an adaptive profile from remote profile store 190 by referencing one or more of device identifier 194 and application identifier 196 in response to receiving a profile retrieval request from profile management module 130 via network 182. In some embodiments, an application may engage profile management module 130 to initiate retrieval of instruction sets and/or adaptive profiles.

FIG. 2 shows an embodiment of an example method 200 of directing graphical user interface elements to an adaptive device. As one example, method 200 may be performed by computing device 110 of FIG. 1. As such, some of the processes of method 200 may be described in the context of computing system 100. However, it should be appreciated that method 200 may be performed by other suitable computing systems.

At 210, the method includes discovering an adaptive device in communication with the computing device. In some embodiments, the process of discovering the adaptive device includes discovering the adaptive device upon initiation of communication between the computing device and the adaptive device. As one example, a device management module (e.g., device management module 132 of FIG. 1) may be configured to discover the adaptive device when the adaptive device initiates wired or wireless communication with the computing device (e.g., via one or more of input interface 116 and output interface 118 of FIG. 1). In some embodiments, the adaptive device that is discovered at 210 may include one or more graphical display fields (e.g., graphical display fields 162 of FIG. 1). In some embodiments, the process of discovering the adaptive device includes identifying a device identifier of the adaptive device. For example, device management module 132 may be configured to identify the device identifier of the adaptive device.

At 212, the method includes retrieving an adaptive profile for the adaptive device. In some embodiments, the process of retrieving the adaptive profile may be performed in response to discovery of the adaptive device at process 210. As one example, the device management module may be configured to forward or provide the device identifier to a profile management module (e.g., profile management module 130 of FIG. 1). The profile management module may be configured to receive the device identifier from the device management module.

In some embodiments, the process of retrieving the adaptive profile includes retrieving the adaptive profile associated with the device identifier. For example, referring to FIG. 1, profile management module 130 may be configured to identify an adaptive profile from a plurality of adaptive profiles by comparing device identifier 166 of first adaptive device 160 to device identifier 146 of adaptive profile 142 or to device identifier 194 of adaptive profile 192.

In some embodiments, a plurality of adaptive profiles may be provided for a particular adaptive device (e.g., as indicated by the device identifier), whereby an adaptive profile may be retrieved from the plurality of adaptive profiles based on other adaptive devices that are in communication with the computing device. For example, some adaptive profiles may be associated with two or more adaptive device identifiers, whereby an adaptive profile associated two or more device identifiers may be retrieved for the two or more adaptive devices that are in communication with the computing device.

In some embodiments, process 212 may include one or more sub-processes that enable the computing device to retrieve the adaptive profile from the appropriate profile store. As one example, the profile management module may be configured to retrieve the adaptive profile from one or more of a local profile store (e.g., local profile store 124 of FIG. 1) residing at the computing device and a remote profile store (e.g., remote profile store 190 of FIG. 1) residing at a profile server.

At 214, the method may include identifying whether the adaptive profile is accessible at the computing device. For example, the profile management module may be configured to identify whether the adaptive profile associated with the device identifier resides at the local profile store. If the adaptive profile is accessible at the computing device (e.g., the answer at 214 is judged yes), then the method at 216 may include retrieving the adaptive profile from a local profile store residing at the computing device. For example, profile management module 130 may be configured to retrieve an adaptive profile from local profile store 124 of FIG. 1.

If the adaptive profile is not accessible at the computing device, then the method at 218 may include retrieving the adaptive profile from a remote profile store (e.g., remote profile store 190 of FIG. 1) residing at a profile server via a network. As one example, the profile management module may be configured to transmit an adaptive profile request to a profile server via the network. The adaptive profile request may indicate or include the device identifier of the adaptive device for which the adaptive profile is sought. A profile retrieval module (e.g., profile retrieval module 188 of FIG. 1) of the profile server may be configured to receive the adaptive profile request from the profile management module and retrieve the adaptive profile associated with the device identifier from the remote profile store. The profile retrieval module may be configured to transmit an adaptive profile response to the profile management module that includes the adaptive profile. The profile management module may be configured to receive the adaptive profile response including the adaptive profile from the profile retrieval module, thereby completing the retrieval process. In some embodiments, the profile management module may be configured to store the adaptive profile at the local profile store where it may be later retrieved.

Additionally or alternatively, the profile management module may utilize an application identifier identifying a software application to retrieve the adaptive profile. In some embodiments, in addition to referencing a device identifier during the adaptive profile retrieval process, an application identifier may be used to provide software application granularity. As one example, adaptive profiles 140 of local profile store 124 of FIG. 1 may include a plurality of adaptive profiles for a particular device identifier. Hence, the profile management module may be configured to retrieve an adaptive profile associated with both the application identifier and the device identifier. In this way, an adaptive profile may be configured for a particular combination of a software application and an adaptive device. Similarly, profile management module may be configured to retrieve an adaptive profile from a remote profile store by transmitting an adaptive profile request that indicates the device identifier and the application identifier, which in turn may be used by the profile retrieval module to retrieve the appropriate adaptive profile for the indicated device identifier and application identifier.

At 220, the method may include receiving one or more graphical user interface elements from a software application via an application programming interface. As one example, operating system 122 of FIG. 1 may be configured to receive the one or more graphical user interface elements (e.g., GUI elements 153) from a software application (e.g., software application 152) via API 138. It should be appreciated that in some embodiments, process 220 may be performed before retrieval of the adaptive profile. In these embodiments, the profile management module may be configured to identify an application identifier of the software application from which the graphical user interface elements are received, and retrieve the adaptive profile that is associated with the device identifier and the application identifier.

At 222, the method may include presenting the graphical user interface elements at the one or more graphical display fields of the adaptive device according to the rule set of the adaptive profile. The one or more graphical display fields may be associated with depressible buttons, touch-sensitive display regions, or gesture-sensitive regions of the adaptive device. For example, if a user is interacting with software application that provides word processing functionality, then graphical elements that relate to the word processor functionality may be presented at the one or more graphical display fields. As one example, a “copy” icon may be presented at a depressible button or touch-sensitive display region that corresponds to a user input that cause the software application to perform a copy function.

The device output module (e.g., device output module 136 of FIG. 1) may be configured to present the graphical user interface elements at the one or more graphical display fields of the adaptive device according to the rule set. In some embodiments, the adaptive profile may be configured to interact with the application instructions (e.g., application instructions 158 of FIG. 1), whereby the software application may determine whether to utilize the adaptive profile to direct graphical user interface elements to the adaptive device or whether to utilize another rule set that is included in the application instructions. Hence, software applications may be provided with the ability to use the adaptive profile or ignore the adaptive profile that is retrieved by the operating system in favor of another rule set.

At 224, the method may include receiving user input from the adaptive device. As one example, a device input module (e.g., device input module 134 of FIG. 1) may be configured to receive the user input via an input device of the adaptive device. For example, the user input may be provided via one or more of a depressible buttons or touch-sensitive regions of the adaptive device. The device input module may be configured to forward the user input that is received from the adaptive device to the software application via the application programming interface or another suitable method. In this way, a user of the computing device may interact with a software application via the adaptive device.

From 224, the process flow of method 200 may return or end. In some embodiments, the process flow of method 200 may return to perform one or more of the previously described processes if other adaptive devices are present. As one example, some or all of the processes of method 200 may be repeated for each additional adaptive device that is in communication with the computing device. For example, at 210, the method may include discovering a second adaptive device in communication with the computing device, which may be performed by the device management module. At 212, the method may include retrieving a second adaptive profile for a second adaptive device, which may be performed by the profile management module. At 222, the method may include presenting one or more of the graphical user interface elements at one or more graphical display fields of the second adaptive device according to a second rule set of the second adaptive profile, which may be performed by the device output module. And, at 224, the method may include receiving user input from the second adaptive device, which may be performed by the device input module.

FIG. 3 shows a non-limiting example of an adaptive device 310 in the context of a computing system 300. It should be appreciated that adaptive device 310 may correspond to first adaptive device 160 of FIG. 1, and computing device 320 may correspond to computing device 110. In this example, adaptive device 310 is in communication with computing device 320, which enables computing device 320 to receive user input via adaptive device 310 as previously described with reference to process 224 of FIG. 2. Communication between adaptive device 310 and computing device 320 also enables adaptive device 310 to be visually adapted by computing device 320 as previously described with reference to process 222 of FIG. 2. Hence, in this example, adaptive device 310 is a graphically adaptable user input device.

As shown in FIG. 3, adaptive device 310 may take the form of an adaptive keyboard. For example, adaptive device 310 may include one or more depressible buttons, including keys 312. In some embodiments, the one or more keys 312 may be depressible to enable a user to provide a user input to computing device 320. Adaptive device 310 may additionally or alternatively include a touch-sensitive display region 314. Touch-sensitive display region 314 may be configured to recognize touch input (e.g., a user input) from a finger or other suitable object, and provide the touch input to computing device 320. In some embodiments, touch-sensitive display region 314 may be adaptively divided into two or more sub-regions 316 by computing device 320.

Adaptive device 310 may include one or more graphical display fields that are configured to display graphical information. For example, some or all of the one or more keys 312 may each provide a graphical display field via a corresponding key display 318. Key display 318 may be dynamically updated by computing device 320 in accordance with an adaptive profile to present graphical information to a user. Touch-sensitive display region 314 may provide one or more other graphical display fields. Where touch-sensitive display region 314 is adaptively divided into two or more sub-regions 316, each of the two or more sub-regions 316 may provide a corresponding graphical display field. In some embodiments, a background display 340 may be provided between one or more keys 312, which may serve as yet another graphical display field. Hence adaptive device 310 may include one or more graphical display fields to which graphical user interface elements may be directed by computing device 320 in accordance with method 200. As shown in FIG. 3, one or more of these graphical display fields may be associated with a particular depressible button or touch-sensitive region of the adaptive device.

Computing device 320 may dynamically update a visual appearance of adaptive device 310 by varying the graphical elements that are presented at the one or more graphical display fields. As one example, adaptive device 310 may have a first visual appearance 350, which may be dynamically changed to a second visual appearance 360 by computing device 320. Hence, one or more graphical display fields of first visual appearance 350 are shown presenting different graphical user interface elements than the second visual appearance 360. For example, the differences in the manner of presentation of the graphical user interface elements may be the result of the addition or removal of an adaptive device, which may cause computing device 320 to retrieve an adaptive profile for directing the graphical user interface elements to the adaptive device that is communication with the computing device.

In some embodiments, computing system 300 may further include one or more monitors, such as first monitor 322 and second monitor 324, which may also communicate with computing device 320. One or more of first monitor 322 and second monitor 324 may be used by computing device 320 in addition to or as an alternative to adaptive device 310 to present graphical information to a user, such as one or more graphical user interface elements. Computing system 300 may further include one or more peripheral input devices, such as peripheral input device 326, which is also in communication with computing device 320. Computing device 320 may receive user input via peripheral input device 326 and display a corresponding graphical output 328 on one or more of first monitor 322 and second monitor 324. For example, in FIG. 3, user input may be received via peripheral input device 326 through an input aid, such as stylus 330.

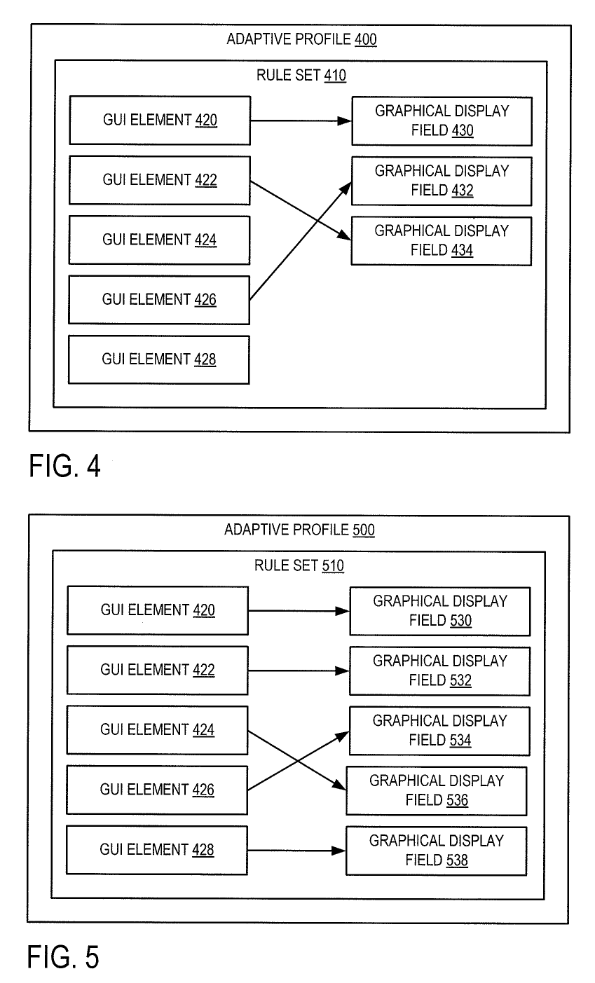

FIG. 4 shows a schematic representation of an adaptive profile 400. It should be understood that FIG. 4 is provided as a non-limiting example. Adaptive profile 400 defines a rule set 410 which directs one or more GUI elements 420, 422, 424, 426, and 428 of a software application to one or more graphical display fields 430, 432, 434 of a first adaptive device. In this example, GUI element 420 is directed to graphical display field 430, GUI element 422 is directed to graphical display field 434, GUI element 426 is directed to graphical display field 432, while GUI element 424 and GUI element 428 are not directed to graphical display fields of the adaptive device.

FIG. 5 shows another schematic representation of an adaptive profile 500, which differs from adaptive profile 400 of FIG. 4. Adaptive profile 500 defines a rule set 510 which directs one or more of previously described GUI elements 420, 422, 424, 426, and 428 of the software application to one or more graphical display fields 530, 532, 534 of a second adaptive device. In this example, GUI element 420 is directed to graphical display field 430, GUI element 422 is directed to graphical display field 532, GUI element 426 is directed to graphical display field 534, GUI element 424 is directed to graphical display field 536, and GUI element 428 is directed to graphical display field 538. Hence, a comparison of adaptive profile 400 and adaptive profile 500 illustrates how GUI elements of a software application may be presented at different graphical display fields depending on the adaptive device that is in communication with the computing device.

It is to be understood that the logic subsystems described herein, including logic subsystem 112 and server logic subsystem 184 of FIG. 1 may each include one or more physical devices configured to execute one or more instructions. For example, logic subsystem 112 may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

It is to be understood that the data-holding subsystems described herein, including data-holding subsystem 114 and server data-holding subsystem 186 may include one or more physical devices configured to hold data and/or instructions executable by the logic subsystem to implement the herein described methods and processes. When such methods and processes are implemented, the state of the data-holding subsystem may be transformed (e.g., to hold different data). Data-holding subsystem may include removable media and/or built-in devices. Data-holding subsystem may include optical memory devices, semiconductor memory devices, and/or magnetic memory devices, among others. Data-holding subsystem may include devices with one or more of the following characteristics: volatile, nonvolatile, dynamic, static, read/write, read-only, random access, sequential access, location addressable, file addressable, and content addressable. In some embodiments, the logic subsystem and the data-holding subsystem may be integrated into one or more common devices, such as an application specific integrated circuit or a system on a chip.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed. The subject matter of the present disclosure includes all novel and nonobvious combinations and subcombinations of the various processes, systems and configurations, and other features, functions, acts, and/or properties disclosed herein, as well as any and all equivalents thereof.

1. A computing device, comprising:
a logic subsystem including a processor;
a data-holding subsystem holding instructions executable by the logic subsystem to:
provide a device management module configured to discover an adaptive device in communication with the computing device, the adaptive device including one or more graphical display fields;
provide a profile management module configured to retrieve an adaptive profile for the adaptive device in response to discovery of the adaptive device, the adaptive profile defining a rule set by which graphical user interface elements are directed to the one or more graphical display fields of the adaptive device; and
provide a device output module configured to present the graphical user interface elements at the one or more graphical display fields of the adaptive device according to the rule set of the adaptive profile.

2. The computing device of claim 1, where the adaptive device is a graphically adaptable user input device.

3. The computing device of claim 1, where the data-holding subsystem is further configured to hold instructions executable by the logic subsystem to provide a device input module configured to receive user input via the adaptive device; and
where the adaptive device includes one or more depressible buttons for receiving the user input.

4. The computing device of claim 1, where the data-holding subsystem is further configured to hold instructions executable by the logic subsystem to provide a device input module configured to receive user input via the adaptive device; and
where the adaptive device includes one or more touch-sensitive regions or gesture-sensitive regions for receiving the user input.

5. The computing device of claim 1, where the profile management module is configured to retrieve the adaptive profile from an adaptive profile server in communication with the computing device via a wide area network.

6. The computing device of claim 1, where the profile management module is further configured to identify whether the adaptive profile is accessible at the computing device; and
if the adaptive profile is accessible at the computing device then the profile management module is further configured to retrieve the adaptive profile from a local adaptive profile store residing at the computing device; or
if the adaptive profile is not accessible at the computing device, then the profile management module is further configured to retrieve the adaptive profile from a remote adaptive profile store residing at an adaptive profile server via a network.

7. The computing device of claim 6, where the profile management module is engageable by an application so that the application may retrieve the adaptive profile.

8. The computing device of claim 1, where the adaptive device is one of a plurality of adaptive devices in communication with the computing device; and
where the device management module is further configured to discover a second adaptive device in communication with the computing device of the plurality of adaptive devices, the second adaptive device including one or more graphical display fields;
where the profile management module is further configured to retrieve a second adaptive profile for the second adaptive device in response to discovery of the second adaptive device, the second adaptive profile defining a second rule set by which graphical user interface elements are directed to the one or more graphical display fields of the second adaptive device; and
where the device output module is configured to present the graphical user interface elements at the one or more graphical display fields of the second adaptive device according to the second rule set of the second adaptive profile.

9. The computing device of claim 1, where the device management module is further configured to identify a device identifier of the adaptive device; and
where the profile management module is configured to retrieve an adaptive profile associated with the device identifier.

10. The computing device of claim 9, where the device management module is further configured to identify a device identifier of the adaptive device; and where the profile management module is further configured to retrieve an adaptive profile associated with both the device identifier and an application identifier of the software application.

11. A method of directing graphical user interface elements to an adaptive device, comprising:
discovering an adaptive device in communication with the computing device, the adaptive device including one or more graphical display fields and one or more depressible buttons for receiving user input;
retrieving an adaptive profile for the adaptive device in response to discovery of the adaptive device, the adaptive profile defining a rule set by which graphical user interface elements are directed to one or more graphical display fields of the adaptive device; and
presenting the graphical user interface elements at the one or more graphical display fields of the adaptive device according to the rule set of the adaptive profile.

12. The method of claim 11, where the adaptive device is a graphically adaptable user input device.

13. The method of claim 11, where retrieving the adaptive profile includes retrieving the adaptive profile from an adaptive profile server in communication with the computing device via a wide area network.

14. The method of claim 11, further comprising:
identifying whether the adaptive profile is accessible at the computing device; and
if the adaptive profile is accessible at the computing device then retrieving the adaptive profile from a local adaptive profile store residing at the computing device; or
if the adaptive profile is not accessible at the computing device, then retrieving the adaptive profile from a remote adaptive profile store residing at an adaptive profile server via a network.

15. The method of claim 11, further comprising, receiving the graphical user interface elements from a software application via an application programming interface.

16. The method of claim 15, further comprising identify a device identifier of the adaptive device; and
retrieving an adaptive profile associated with both the device identifier and an application identifier of the software application.

17. The method of claim 11, where the adaptive device is one of a plurality of adaptive devices in communication with the computing device; and where the method further comprises:
discovering a second adaptive device in communication with the computing device of the plurality of adaptive devices, the second adaptive device including one or more graphical display fields;
retrieving a second adaptive profile for the second adaptive device in response to discovery of the second adaptive device, the second adaptive profile defining a second rule set by which graphical user interface elements are directed to the one or more graphical display fields of the second adaptive device; and
presenting the graphical user interface elements at the one or more graphical display fields of the second adaptive device according to the second rule set of the second adaptive profile.

18. The method of claim 11, where discovering the adaptive device includes identifying a device identifier of the adaptive device; and
where retrieving the adaptive profile includes retrieving an adaptive profile associated with the device identifier.

19. A method of directing graphical user interface elements to an adaptive device, comprising:
identifying a first device identifier of a first graphically adaptable user input device in communication with the computing device, the first graphically adaptable user input device including one or more graphical display fields and one or more depressible buttons associated with the one or more graphical display fields;
retrieving a first adaptive profile associated with the first device identifier from a remote adaptive profile store via a wide area network, the first adaptive profile defining a first rule set by which graphical user interface elements are directed to the one or more graphical display fields of the first graphically adaptable user input device;
receiving the graphical user interface elements from a software application via an application programming interface;
presenting the graphical user interface elements at the one or more graphical display fields of the first graphically adaptable user input device according to the first rule set of the first adaptive profile;
identifying a second device identifier of a second graphically adaptable user input device in communication with the computing device, the second graphically adaptable user input device including one or more graphical display fields and one or more depressible buttons associated with the one or more graphical display fields;
retrieving a second adaptive profile associated with the second device identifier from a remote adaptive profile store via a wide area network, the second adaptive profile defining a second rule set by which the graphical user interface elements are directed to the one or more graphical display fields of the second graphically adaptable user input device; and
presenting the graphical user interface elements at the one or more graphical display fields of the second graphically adaptable user input device according to the second rule set of the second adaptive profile.

20. The method of claim 19, further comprising, identifying an application identifier of the software application; and
where retrieving the first adaptive profile includes retrieving an adaptive profile associated with both the first device identifier and the application identifier of the software application.
